(19) United States
(12) Patent Application Publication
(10) Pub. No.: US 2008/0158641 A1
(43) Pub. Date: Jul. 3, 2008

(54) BACKLIGHT UNIT AND AN IMAGING SYSTEM USING THE SAME

(75) Inventor: David Foster Lieb, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/958,703

(22) Filed: Dec. 18, 2007

Related U.S. Application Data
(60) Provisional application No. 60/882,759, filed on Dec. 29, 2006.

(51) Int. Cl. G02F 1/313; G09G 3/00; G02F 1/29

(52) U.S. Cl. 359/263; 359/240; 345/589

(57) ABSTRACT

A backside light unit employs a light valve having an array of individually addressable pixels for illuminating direct view imaging panels.

### CROSS-REFERENCE

This US patent application claims priority from co-pending U.S. provisional patent application 60/882,759 to Lieb, filed Dec. 29, 2006, the subject matter being incorporated herein by reference in its entirety.

### TECHNICAL FIELD

The technical field of this disclosure relates to the art of imaging systems, and more particularly, to backlight units for illuminating transmissive or semi-transmissive direct view panels of direct view image systems.

### BACKGROUND

A typical direct-view image system, such as a direct-view liquid-crystal display system, comprises a direct-view panel, such as a direct-view liquid crystal panel. The direct-view panel comprises an array of pixels, by which desired images can be displayed on the direct-view panel and directly viewed by viewers. In general, a direct-view panel has a size that is equal to or larger than the size of the image displayed thereon.

Unlike emissive displays, such as plasma display panels and micro-display projection displays, direct-view image systems often need backside lightening mechanisms to illuminate pixels of the direct-view panels in the direct-view image systems.

Therefore, what is desired is a backside lightening mechanism for illuminating pixels of direct-view panels in direct-view image systems.

### SUMMARY

In one example, an imaging system is provided. The system comprises: an illumination system that comprises: a light valve having an array of individually addressable pixels for providing light; and a direct-view panel having an array of individually addressable pixels, wherein the direct-view panel is coupled to the pixels of the light valve such that light from the pixels of the light valve is capable of being directed to and modulated by the pixels of the direct-view panel.

In another example, a system for use in a direct-view image system for delivering light onto a rear side of a direct view panel of the direct-view image system is provided. The system comprises: a light valve having an array of individually addressable pixels; and a light-guide assembly comprising: an elongated light-guide; a tapered light-guide; and an total-internally-reflective surface coupled to an exit end of the elongated light guide and to an entrance of the tapered light guide such that light exiting from the exit end of the elongated light guide is capable of being delivered to the entrance of the tapered light-guide.

In yet another example, a method for producing an image is provided. The method comprises: generating an intermediate image based upon the image to be produced using an array of individually addressable pixels of a light valve; projecting the intermediate image onto a rear side of a direct view panel comprising an array of individually addressable pixels; and modulating the light of the intermediate image by the pixels of the direct-view panel so as to produce the image.

In still another example, a method of displaying an image is disclosed. The method comprises: illuminating a first array of pixels with light; modulating the light by a first array of pixels based upon one of a luminance component and a chromatic component of the image so as to generate an image component; projecting said image component onto a second array of pixels; and modulating the light of said image component by the second array of pixels based upon the other one of the luminance component and the chromatic component so as to produce the image.

In yet another example, a method of displaying an image is provided. The method comprises: generating a luminance image component of the image by a first array of pixels; generating a chromatic image component of the image by a second array of pixels; and causing the generated luminance and chromatic image components to be displayed so as to produce the image.

### BRIEF DESCRIPTION OF DRAWINGS

FIG. 1 schematically illustrates an exemplary direct view image system that employs a backlight unit of this disclosure;

FIG. 2 illustrates a perspective view of an exemplary light-guide of the backlight unit in FIG. 1;

FIG. 3a illustrates a perspective view of an exemplary tapered light-guide of the backlight unit in FIG. 1;

FIG. 3b illustrates a perspective view of another exemplary tapered light-guide of the backlight unit in FIG. 1;

FIG. 4 schematically illustrates a portion of an exemplary micromirror array for use in the light valve of the backlight unit in FIG. 1;

FIG. 5 schematically illustrates an exemplary arrangement of the light valve pixels of the backlight unit and the pixels of the direct view panel in the direct view image system in FIG. 1;

FIG. 6 schematically illustrates another exemplary arrangement of the light valve pixels of the backlight unit and the pixels of the direct view panel in the direct view image system in FIG. 1;

FIG. 7 schematically illustrates yet another exemplary arrangement of the light valve pixels of the backlight unit and the pixels of the direct view panel in the direct view image system in FIG. 1;

FIG. 8 schematically illustrates yet another exemplary arrangement of the light valve pixels of the backlight unit and the pixels of the direct view panel in the direct view image system in FIG. 1;

FIG. 9 schematically illustrates an exemplary least-significant-bit achievable by the direct-view image system as shown in FIG. 1; and

FIG. 10 is a diagram showing an exemplary method of producing high dynamic range images using the direct view image system in FIG. 1.

### DETAILED DESCRIPTION OF EXAMPLES

Disclosed herein is a backlight unit that is capable of illuminating pixels of direct view panels in direct view image systems. The backlight unit employs a light valve that comprises an array of individually addressable pixels and a light guide assembly that delivers the light from the light valve to the direct view panel of the direct view image system. The light guide assembly is capable of expanding light from the light valve pixels in a plane that is substantially parallel to the pixels of the direct view panel such that the pixels of the direct view panel can be illuminated by the light from the light valve pixels. The backlight unit and its application to direct view display systems will be discussed in the following with reference to selected examples. However, it will be appreciated by those skilled in the art that the following discussion is for demonstration purpose; and should not be interpreted as a limitation. Other variations within the scope of this disclosure are also applicable.

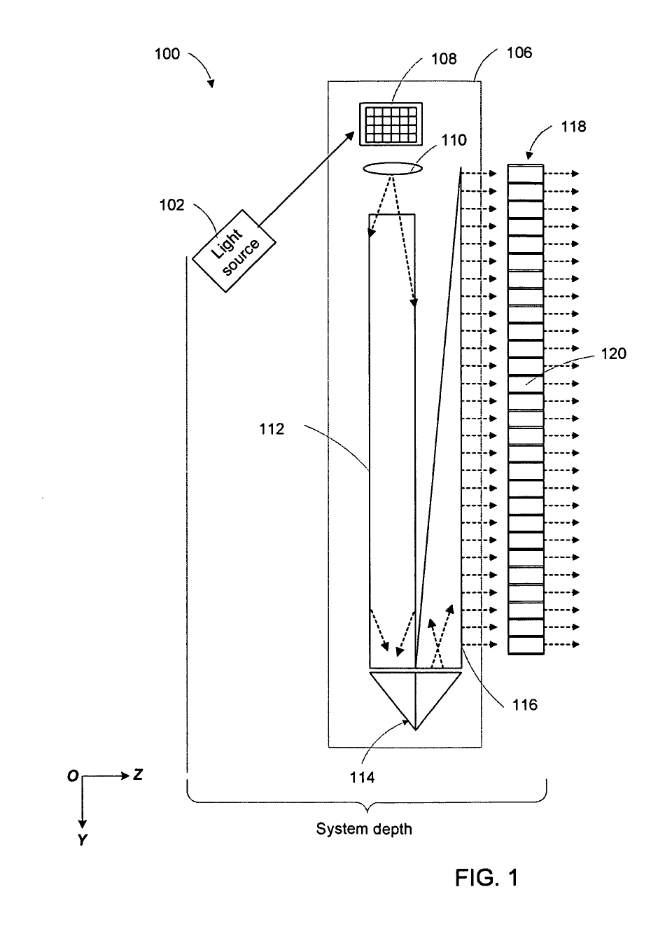

Referring to the drawings, FIG. 1 schematically illustrates an exemplary direct-view image system that employs an exemplary backlight unit. In this example, direct view image system 100 comprises backlight unit 106 and direct view panel 118.

The direct view panel (118) can be a transmissive direct view panel that comprises an array of individually addressable transmissive pixels, such as liquid-crystal devices. Alternatively, the direct view panel (118) can be a semi-transmissive direct view panel that comprises an array of individually addressable semi-transmissive devices, such as liquid-crystal cells, each of which comprises a portion that is transmissive to visible light and another portion that is reflective to visible light. The direct view panel may have other suitable pixels. The direct view panel (118) may have other desired features, such as sub-pixel color filters for generating color images, which is not shown in the figure for simplicity.

The direct view panel (118) may have any desired total number of pixels, which is often referred to as the native resolution of the direct view panel. For example, the direct view panel may have a native resolution of 640×480 (VGA) or higher, such as 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher. Of course, the direct view panel may have other desired native resolutions.

Backlight unit 106 is designated for illuminating the pixels of the direct view panel (118) from the rear side of the direct view panel; while the front side of the direct view panel is to be used for displaying the desired image. In the example as illustrated in FIG. 1, the backlight unit (106) comprises light valve 108, condensing lens 110, and a light guide assembly that comprises elongated light-guide 112, optical element 114, and tapered light-guide 116 that is implemented as a wedge light guide.

Light valve 108 comprises an array of individually addressable pixels that can be any suitable types of devices. For example, the light valve pixels can be reflective pixels (e.g. reflective and deflectable micromirrors or liquid-crystal-on-silicon devices), transmissive pixels (e.g. liquid-crystal devices), self-light emitting devices (e.g. plasma cells, organic light-emitting diodes (OLED), and surface-conduction electron-emitter displays (SED), or other suitable pixels. The light valve (108) may have any suitable native resolutions, such as 640×480 (VGA) or higher, 800×600 (SVGA) or higher, 1024×768 (XGA) or higher, 1280×1024 (SXGA) or higher, 1280×720 or higher, 1400×1050 or higher, 1600×1200 (UXGA) or higher, or 1920×1080 or higher. Of course, other native resolutions are also applicable. When the light valve pixels are not self-light emitting devices, such as reflective or transmissive pixels, external illumination light can be provided. In one example, the external illumination light can be provided by light source 102.

When used in direct view image system 100, light source 102 may comprise any suitable types of illuminators, such as arc lamps or solid state illuminators (e.g. lasers and light-emitting-diodes). When lasers or LEDs are used, the light source may comprise multiple lasers or LEDs to obtain sufficient light intensity. For example, white light can be used to illuminate the light valve pixels, in which instance, the direct view panel may comprise a sub-array color filter for obtaining colors. The white light can be produced my multiple solid-state illuminators that have substantially the same characteristic spectrum (e.g. white light). Alternatively, a set of solid-state illuminators capable of emitting light of selected colors can be used together such that the combination of the selected colors forms the white color. Light of each one of the selected colors can be provided by one or multiple solid-state illuminators. In examples wherein light of selected colors (e.g. red, green, and blue) is to be used for sequentially illuminating the light valve pixels or illuminating the light valve pixels according to a specific duty-cycle, light of each color can be provided by one or multiple solid-state illuminators.

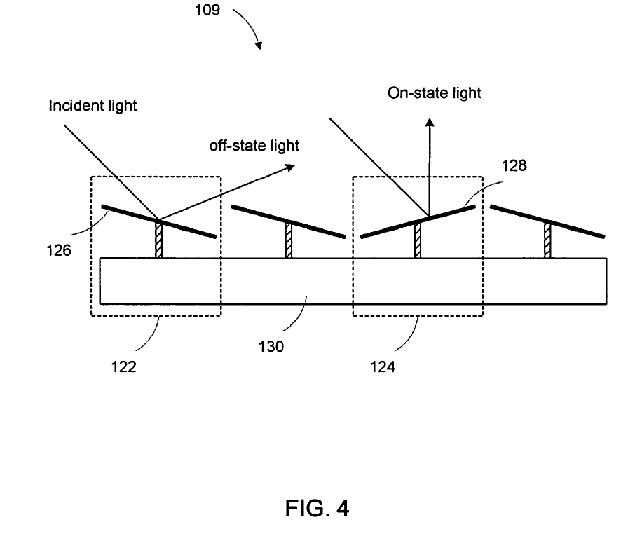

For demonstration purpose, FIG. 4 schematically illustrates a cross-sectional view of a portion of an exemplary array of micromirrors, which can be used in the light valve (108). For simplicity purpose, only 4 micromirrors are illustrated therein. Each micromirror, such as micromirror 122 and micromirror 124, comprises a mirror plate (e.g. mirror plate 126 of micromirror 122 and mirror plate 128 of micromirror 124) formed on substrate 130. The substrate can be a semiconductor substrate or other suitable substrates such as substrates that are transmissive to visible light (e.g. glass, quartz, and sapphire). Each mirror plate has a reflective surface for reflecting visible light; and each mirror plate is held on the substrate such that the mirror plate is capable of moving to multiple angles relative to the substrate. The movement of the mirror plate can be accomplished by electronic torque derived from an electrostatic field established between the mirror plate and an addressing electrode associated with the mirror plate, which is not shown in the figure for simplicity. The mirror plate can alternatively be moved by other methods, such as electromagnetic forces, which will not be discussed in detail herein. Because the mirror plates are capable of being moved to different angles or positions, a beam of incident light can thus be reflected to different spatial directions, a process of which is referred to as spatial modulation of the incident light. Accordingly, the mirror plate at different angles or positions are defined as different operation states, such as an ON and an OFF state of the micromirrors when the micromirrors are to be operated at binary states. In other examples, other intermediate states than the ON and OFF states can also be defined.

In the example as shown in the figure wherein the micromirrors are operated at a binary state, the incident light is modulated to off-state light by the micromirrors (e.g. micromirror 122) at the OFF state; and the incident light is modulated to ON state light by micromirrors (e.g. micromirror 124) at the ON state. The off-state and on-state light travel along different spatial directions. In the example as shown in FIG. 1, the ON state light (or the OFF-state) light can be directed to the pixels of direct view panel 118; while the OFF state light (or the ON state light) is directed away from the pixels of the direct view panel. It is noted that the micromirrors in FIG. 4 are only one of many possible examples. Other micromirrors are also applicable.

Referring again to FIG. 1, condensing lens 110 collects the on-state light (or the off-state light) from the light valve (108) and directs the collected light to light-guide 112 of the light guide assembly. The condensing lens (110) can be disposed such that a focal plane of the condensing lens (110) is substantially at the pixels of light valve (108) and another focal plane of the condensing lens is substantially at the entrance of light guide 112. With such configuration, pixels of the light valve can be imaged at the entrance of light guide 112.

In another example, the condensing lens (110) can be disposed at a location such that the pixels of the light valve are imaged on an image plane located inside the light-guide (112). Of course, other optical arrangements are also applicable. However, to optimize the optical efficiency, the light valve, the condensing lens, and the light-guide (112) are disposed relative to each other such that substantially no on-state light (or off-state light) from the light valve is lost from the light valve to the entrance of the light-guide (112).

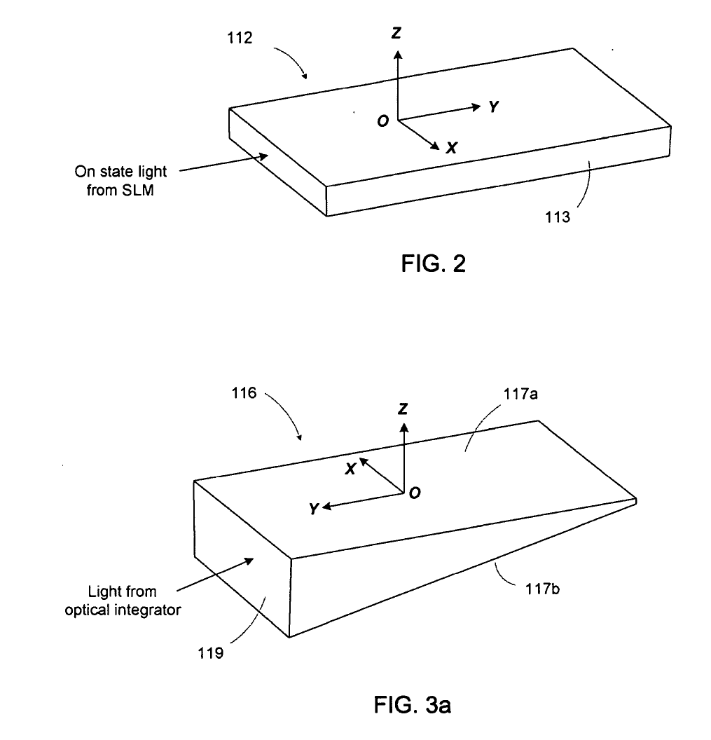

Light-guide 112 can be any suitable light guide, such as a solid optical integrator or a hollow optical integrator (which are often referred to as optical integrator tunnels). However, it is preferred that light guide 112 is a thin plate, which will be detailed afterwards with reference to FIG. 2. Light guide 112 is capable of expanding the incident light (from the light valve pixels) in a two-dimensional plane (e.g. the XY plane in the Cartesian coordinate shown in the figure) that is substantially parallel to the plane (or pixel array) of direct view panel 118. The spatial extension of the incident light along the vertical direction (e.g. the Z direction of the Cartesian coordinate), however, may substantially remain unchanged during the propagation within light guide 112. With reference to the Cartesian coordinate in FIG. 1, a perspective view of light-guide 112 is illustrated in FIG. 2.

Referring to FIG. 2, the cross-section of the light guide (112) in the XZ plane of light-guide 112 can be a rectangle, square, or any other suitable shapes. Though not required, each one of the top and bottom surfaces of light guide 112, such as top and bottom surfaces parallel to the XY plane, can have a shape that matches the pixel array of the direct view panel (118 as illustrated in FIG. 1). In one example, the top and/or the bottom surfaces of light guide 112 can have a geometric shape that is substantially the same as the shape of the pixel array of the direct view panel; and an area that is substantially equal to the area of the pixels array of the direct view panel. The top and bottom surfaces of the light-guide can be substantially parallel, but may or may not be the same.

The side walls (e.g. side wall 113 and the side wall opposite to side wall 113) can be substantially parallel, and each can be substantially perpendicular to the top and/or the bottom surfaces of light guide 112. In other examples, the side walls may not be parallel, in which instances, the side walls can preferably be disposed to converge towards the exit end of light-guide 112.

Referring again to FIG. 1, light-guide 112 can be disposed in the backlight unit (106) such that the focal plane of condensing lens is substantially at the entrance of light guide 112 or within light guide 112. The top and/or the bottom surfaces can be substantially parallel to the pixels array of direct view panel 118. The principal axis of the light from light valve 108 and propagating within light guide 112 is substantially parallel to the pixel array of direct view panel 118.

In operation, modulated light from the light valve (108 in FIG. 1) enters from the entrance of light-guide 112 and expands in the lateral direction, such as in the XY plane as shown in the Cartesian coordinate in FIG. 2. The light may not expand in the vertical direction (i.e. the Z direction). As an example with the assumption that the modulated light from the light valve forms an image with a dimension of xᵢ×zᵢ, (e.g. 1 by 1 inch in the XZ plane), the output light from the exit end of light-guide 112 may form an image with the size of xₒ×zₒ (e.g. 20 inches by 1 inch), wherein xₒ>xᵢ; and zₒ is approximately the same as zᵢ.

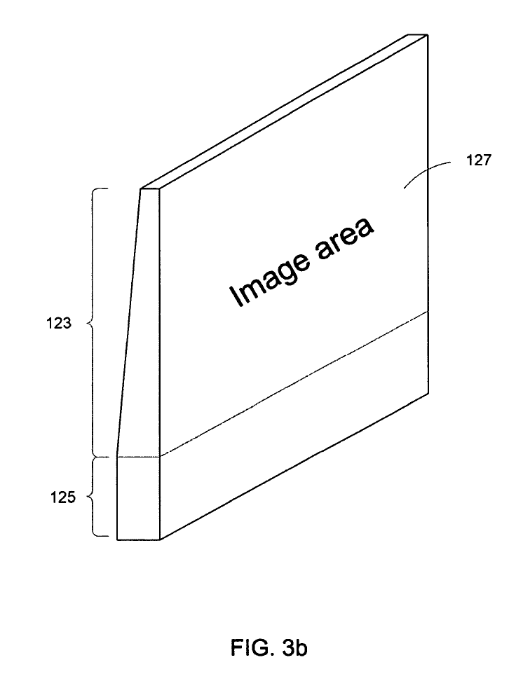

The exit end of light guide 112 is coupled to optical element 114 that comprises a totally-internally-reflective surface. As such, the light exit from the exit end of light guide 112 is directed to the entrance of tapered light guide 116 by the totally-internally-reflective surface of optical element 114. The tapered light-guide (116) distributes the received light across an exit surface (e.g. the top surface 116) from which the light inside the tapered light guide exits the tapered light guide towards the pixels of direct view panel 118. The exit light from the tapered light guide can have an illumination field that matches the pixels array of the direct view panel such that substantially all pixels of the direct view panel can be illuminated by the light exit from tapered light guide 116. For demonstration purpose and with reference to the Cartesian coordinate in FIG. 1, a perspective view of an exemplary tapered light guide is schematically illustrated in FIG. 3a.

Referring to FIG. 3a, tapered light-guide 116 comprises top surface 117a and bottom surface 117b. Top surface is the exiting surface from which the light inside the tapered light guide exits the tapered light guide for illuminating the pixels of the direct view panel. Accordingly, the top surface (117a) may have a shape that is substantially the same as the shape and/or area of the pixel array in the direct view panel (118 illustrated in FIG. 1). The bottom surface (117b) of the tapered light guide can be tapered. Specifically, relative to the exiting top surface (117a) that is substantially parallel to the pixel array of the direct view panel and/or is substantially perpendicular to the plane of entrance side 119 from which modulated light enters (from optical lens 114 in FIG. 1), the bottom surface (117b) is not perpendicular to the plane of the entrance side; and instead forms an acute angle to the exiting top surface 117a. With this configuration, the light propagating within tapered light guide 116 can be distributed across the exiting top surface (117a) and exits from the exiting top surface.

In one example, the tapered light-guide can be configured such that the light inside the tapered light guide (116) can be expanded along the vertical direction (e.g. along the Z direction in the Cartesian coordinate as shown in the figure); while maintains its lateral dimension in the XY plane. As an example with the assumption that the light at the entrance of tapered light-guide 116 forms an image with a dimension of xₒ×zₒ, (e.g. 20 by 1 inch in the XZ plane), the output light from the exit surface (117a) of the tapered light guide (116) may form an image with a dimension of xₑ×zₑ (e.g. 20 inches by 20 inches), wherein zₑ>zₒ; and xₑ is approximately the same as xₒ.

The light exiting from the exit surface (117a) of the tapered light guide can be substantially along the normal direction (e.g. along the Z direction of the Cartesian coordinate as shown in the figure) of the exiting top surface (117a). This can be accomplished by adjusting the relative positions of the reflective walls of the light-guide, such as by adjusting the acute angle between the exiting top surface (117a) and the taped bottom surface (117b). Alternatively, a micro-patterned tuning screen can be used. In other examples, the tapered light-guide (116) can be configured such that the light exits along a pre-determined direction that is not parallel to the normal direction of the pixel array of the direct view panel. Depending upon different applications, the tapered light-guide (116) may have other alternative features. For example, an optical component, such as an array of micro-lenses, an optical filter, and/or an optical diffuser, can be formed or attached to the exiting top surface (117a) so as to control the propagation path of the exit light and/or to adjust the optical performance or efficiency. The bottom surface (117b) of the tapered light-guide may also have subtle features, which may or may not be the same as those in the exiting top surface.

By way of example, a non-tapered light guide portion can be attached to the tapered light guide (116), as schematically illustrated in FIG. 3b. Referring to FIG. 3b, the light guide comprises a tapered portion 123 that can be the tapered light-guide (116) as described above with reference to FIG. 3a; and a non-tapered portion 125 attached to an end of the tapered portion 123. In this particular example, the top surface (exiting surface 127) can be used to define an image area from which the light inside the light-guide can exit, for example towards the viewer such that the exit light forms the desired image to be viewed by the viewer.

Referring again to FIG. 1, by using the backlight unit (106), the direct view image system (100) can have a small system depth that is measured as the maximum distance between components of the direct view image system (100) along the normal direction (e.g. the Z direction) of the direct view panel. In one example, the direct view image system (100) may have a depth of 30 inches or less, 20 inches or less, 15 inches or less, 10 inches or less, 5 inches or less, 3 inches or less, 1 inch or less, or 0.5 inch or less.

Regardless of different possible arrangements and system configurations, it is preferred that the pixels of light valve 108 can be imaged onto the pixel array of direction view panel 118. In one example wherein the pixels of the light valve and the direction view panel have substantially the same or similar profile (e.g. the same pixel size, pitch, and gap), each light valve pixel can be imaged to a direction pixel; and the image of each light valve pixel is substantially aligned to a direct view panel pixel. In other examples, the pixel array of the light valve may not match the pixel array of the direction view panel. For example, the pixel array of the light valve may have a different resolution than the pixel array of the direct view panel. The pixels of the light valve may have different pixel size, different pitches (the distance between adjacent pixels in the array), and/or different gaps (the shortest distance between adjacent pixels in the array). When the pixel arrays of the light valve and the direct view panel do not match, the pixels of the light valve may not be aligned to pixels of the direct view panel.

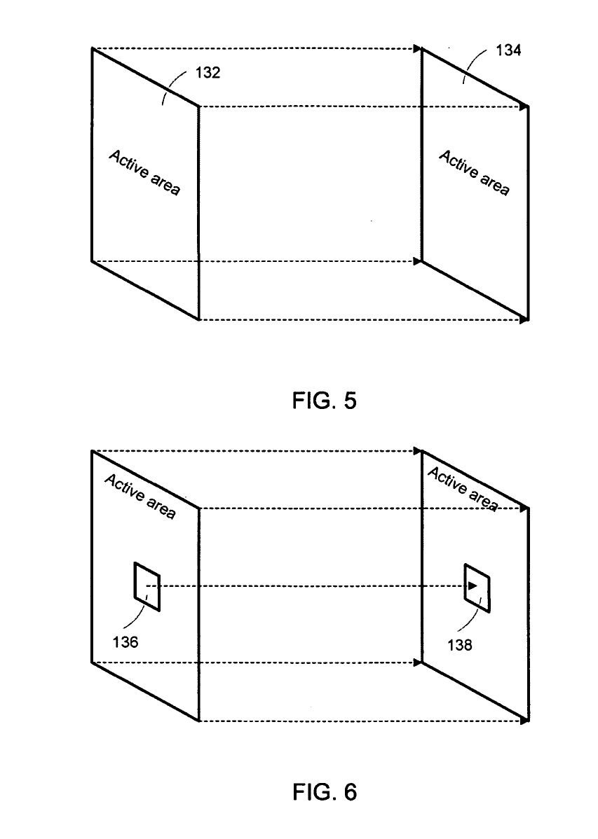

Exemplary mapping schemes for mismatching pixels arrays of the light valve and the direct view panel will be discussed in the following with reference to FIG. 5 through FIG. 8. Referring to FIG. 5, the light valve and the direct view panel are disposed such that active area 132 of the light valve is substantially aligned to active area 134 of the direct view panel. An active area of a pixel array in the light valve of the direct view panel is referred to as a sub-array or the entire array of pixels that are operated based on the images (e.g. based on the bitplanes derived from the desired images) to be produced during image displaying applications. By turning on and off the individual pixels of the light valve, the light incident thereto from the light source can be modulated based on the image to be displayed. The modulated light can be projected to the pixel array of the direct view panel. The light of the projected images can further be modulated by the pixels of the direct view panel. As such, the dynamic range of the direct view image system can be D₁×D₂, wherein D₂:1 is the contrast ratio of the direct view image system without the light valve (108 in FIG. 1); and D₁:1 is the contrast ratio of the light valve (108 in FIG. 1). In one example, the direct view image system can have a dynamic range of 2000:1 or higher. In a typical example wherein D₁ and D₂ are around 1000:1, the direct view image system can have a dynamic range of 10⁶:1 or higher, which exceeds human visual capability for natural scenes.

In one example, the light valve pixels can be illuminated by white light. The light valve pixels modulate the incident white light based upon the lumens of the image to be displayed; while the pixels of the direct view panel modulates the light of the projected image based upon the chromaticity of the image to be displayed. In this instance, the direct view panel may be provided with a sub-array color filter to accomplish chromaticity modulation.

In another example, light of selected colors, such as colors selected from red, green, blue, yellow, cyan, magenta, and any combinations thereof, can be sequentially directed to the pixels of the light valve. The light valve pixels modulate the incident light of a specific color based on the chromaticity of the image to be displayed. The modulated light is then directed to the direct view panel. Pixels of the direct view paned modulate the light from the light valve based on the lumens of the image to be displayed. The modulated light from the direct view panel forms the desired image, and can then be directly viewed.

In addition to the dynamic range, a large number of grayscale levels can be obtained between the dark-black and bright-white levels. For example, 10 bits or more and 16 bits or more grayscale levels can be enabled.

As an aspect of the example, pixels of the light valve and the direct view panel can be accurately aligned such that each pixel (such as pixel 136) of the light valve is imaged and substantially aligned to a pixel (e.g. pixel 138) of the direct view panel, as schematically illustrated in FIG. 6. It is noted that, the light valve and the direct view panel in this instance may or may not have the same native resolution.

As another aspect of the example, a subgroup of pixels of the light valve can be imaged and aligned to one or a subgroup of pixels of the direct view panel. The pixels of the subgroup in the light valve (or the direct view panel) can be the pixels in the same row or the same column in the pixel array of the light valve (or the direct view panel). The subgroup of pixels can alternatively be a m×n pixel block, such as 2×2 pixel block, 2×3 pixel block, and 3×3 pixel block in the light valve or the direct view panel.

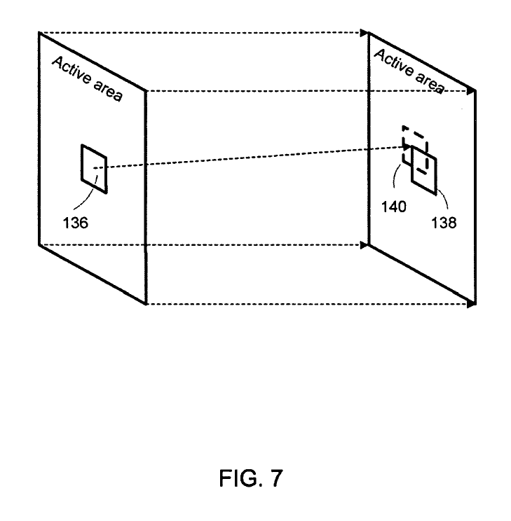

As yet another aspect of the example, pixels of the light valve and pixels of the direct view panel can be aligned such that the pixel array of the light valve is shifted a pre-determined distance along a pre-determined direction relative to the pixel array of the direct view panel, as schematically illustrated in FIG. 7.

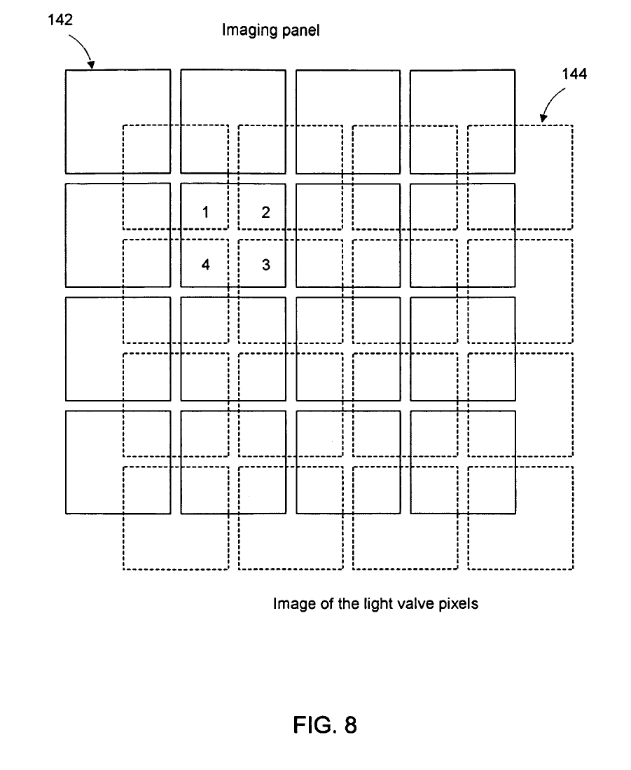

Referring to FIG. 7, image 140 of pixel 136 of the light valve is shifted by half the diagonal distance of pixel 138 of the direct view panel along the diagonal of pixel 138 or along the diagonal of the pixel array of direct view panel or any other desired directions. Such alignment is better illustrated in a top view as shown in FIG. 8.

Referring to FIG. 8, because of the position offset, the image of a light valve pixel is imaged to four adjacent pixels (or other numbers of pixels) of the direct view panel. Each pixel of the direct view panel is optically partitioned into four areas (e.g. areas 1, 2, 3, and 4 as shown in the figure), each of which is illuminated by separate images of four adjacent pixels of the light valve. The effective resolution (e.g. the perceived resolution of the displayed image) of such direct view image system can be (2N−1)×(2N−1), wherein each of the light valve and the direct view panel has N×N native resolutions. Because N is much larger than 1, which is common for most of current light valves and direct view panels, the effective resolution of the direct view image system can be simplified as 4N×N, which is 4 times the resolution of a direct view image system having a direct view panel with a native resolution of N but without the light valve as described above. At the same time, the direct view image system can achieve a dynamic range of substantially D₁×D₂ and a bit depth of 10 bits or more or 16 bits or more.

As another example, the above pixel alignment scheme is applicable to instances wherein a light valve pixel is imaged and aligned to a group of direct view panel pixels; or instances wherein a group of light valve pixels is imaged and aligned to a single direct view panel pixel. For example, each dashed open square of pixel array 144 in FIG. 8 can represent an image of a single pixel of the light valve, whereas each solid open square of pixel array 142 represents a block of pixels (e.g. 2×2 pixel block, 2×3 pixel block, and 3×3 pixel block) of a direct view panel.

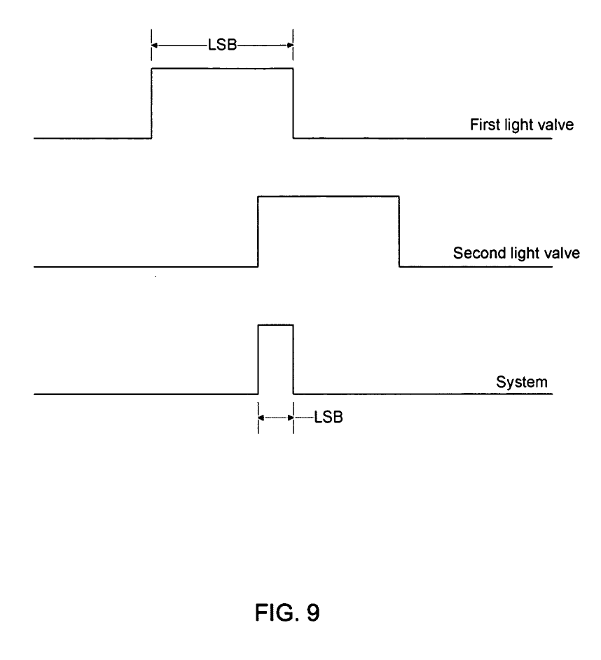

In the example wherein the pixels of the light valve can be substantially aligned to pixels of the direct view panel, even though pixel images of the light valve may be offset from the corresponding pixels of the direct view panel, the pixels of the direct view panel and the light valve together determine the illumination intensity of the pixels of the produced image. This implies that either one of the light valve and the direct view panel can turn off an image pixel of the produced image. Such fact enables the accomplishment of an extremely small least-significant-bit (LSB), such as a LSB that is 7 microseconds or less, 5 microseconds or less, and 600 nanoseconds or less. Specifically, a LSB can be defined by a rising edge of a pixel from one of the light valve and the direct view panel (e.g. the time for turning on the pixel), and a falling edge (e.g. the time for turning off a pixel) of a pixel of the other one of the light valve and the direct view panel, as schematically illustrated in FIG. 9.

Referring to FIG. 9, the system LSB can be defined such that the rising edge of the LSB corresponds to the rising edge of the second light valve that can be either one of the light valve and the direct view panel, but more preferably the fastest rising edge of the light valve and the direct view panel. The falling edge of the system LSB can be defined as the falling edge of the first light valve (the other one of the light valve and the direct view panel). Such way of LSB definition provides significant flexibility of light valve (including the light valve and the direct view) design and fabrication; while is still capable of providing small LSB. This way of LSB definition is of particular importance for light valves (e.g. light valves and direct view panel) wherein pixels have asymmetric ON and OFF response time. In examples when the pixels of the light valve are micromirrors, the micromirrors may have different ON and OFF response time, which resulting in different rising and falling edges of the LSB. This often occurs especially when each micromirror has one single addressing electrode, and the mirror plate of the micromirror turns on in response to an electrostatic field, whereas turns off in response to mechanic deformation stored in a deformable hinge. For systems using light valves whose pixels exhibit asymmetric ON and OFF responses, the LSB can be defined by the faster rising edge and falling edge of the pixels of the direct view panel and light valve. In fact, when the falling edge of the pixels of the first light valve (i.e. the light valve) and the rising edge of the pixels of the second light valve (i.e. the direct view panel) are combined to define the system LSB, the first light valve can be designated to sacrifice the stringent requirement for the rising edge (turning ON response) so as to improve other pixel properties or to meet other pixel requirement. Similar to the second light valve, designing the second light valve may sacrifice the falling edge (turning OFF response) when needed.

Moreover, a large number of grayscale levels can be provided between the dark-black level and bright-white level. For example, 10 bits or more and 16 bits or more grayscale levels can be enabled. The larger number of grayscales in turn unfetters the imaging system from dithering in presenting grayscale levels.

As a way of example, one of the light valve and the direct view panel can be designated for providing grayscale levels of desired images on a screen; and the other can be designated for presenting sharp image features of the desired images on the screen. Specifically, the light valve (108 in FIG. 1) can be designated for producing low frequency portion of the desired image (e.g. the blurred image). The direct view panel (118 in FIG. 1) in this example can be operated with a set of image compensation data that is derived by scaling the input image data with the image data for the light valve (108), accounting for any optical effects introduced by the lenses and light-guides. For example, if the light valve comprises pixels that are binary devices, thus are incapable of producing instantaneous gray shades, true grayscale levels can be obtained by forming the image on the light valve using a binary dither pattern and defocusing the light valve (thus the image formed on the imaging panel) from the direct view panel (118 in FIG. 1) so as to cause blurred image on the imaging panel. When blurred, the binary dither pattern on the light valve forms a true grayscale light intensity distribution across the imaging panel. Alternatively, the image on the light valve can also be preprocessed with typical image processing techniques, including, but not limited to, image dilation and low-pass filtering. The direct view panel in this example can be operated with a set of compensation data that is derived by scaling the input image by the image displayed by the light valve, accounting for any defocus or other optical effects.

In another example wherein the light valve is capable of producing instantaneous gray shades (such as an analogue LCD panel), it may not be necessary to use a binary dither pattern on the light valve. It may not be necessary to defocus the image of the light valve on the direct view panel either. However, defocusing the light valve to the direct view panel can loosen the alignment tolerances.

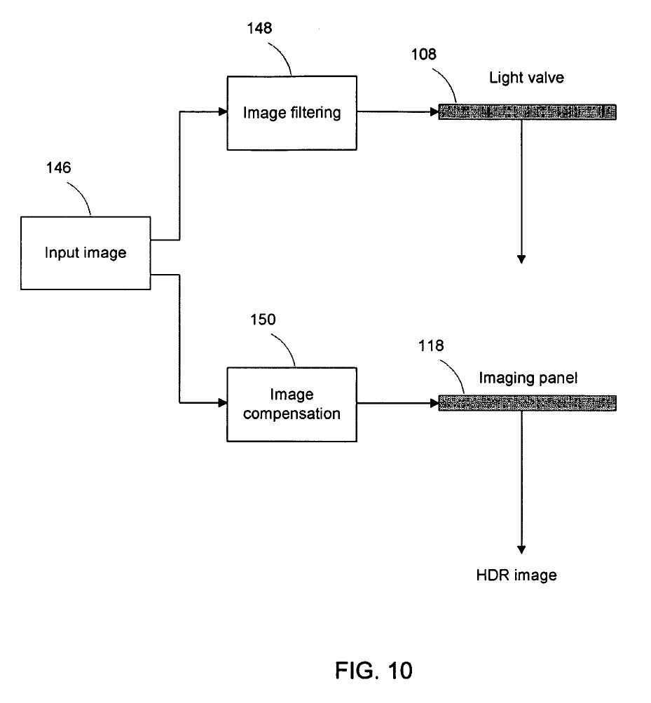

Examples as disclosed herein can be implemented in many ways in direct view image systems, one of which is shown in FIG. 10. Referring to FIG. 10, luminance channel (and/or chrominance channel) of input image 146 can be delivered to imaging filtering module 148. The imaging filtering module may comprise a low-pass filter for filtering out the high-frequency portion of the input image based on a pre-determined low-pass threshold. The imaging filtering may have other functional modules for performing other desired functions, such as binary and/or temporal dithering and/or image dilation. The filtered image after the imaging filtering is delivered to light valve 108 for imaging. The image produced by the light valve is then projected to direct view panel 118.

All other channels, such as the color luminance channels (e.g. Red, Green, Blue, and White, or Cyan, Magenta, Yellow, and White) are delivered to image compensation module 150 for processing. In one example, the image compensation module derives a set of image data by scaling the input image data with the image data output from the image filtering module and delivered to the light valve, accounting any optical effects, such as optical blur.

The processed image data output from the image compensation module is then delivered to direct view panel 118. The direct view panel produces an image based on the processed image data from the image compensation module. Because the image produced by the light valve is projected on the direct view panel during the production of the image by the imaging panel, the final image after the direct view panel is a combination of the images produced by both illumination and imaging panels.

The above system configuration has many advantages. For example, in addition to the high dynamic range and small LSB as afore discussed, true gray shades of produced images can be achieved because of the optical blur of the image by the light valve. A light meter measuring a large smooth region of the produced image can see a substantially uniformity over time. This significantly reduces potential artifact introduced by using pulse-width-modulation techniques for generating grayscales.

It will be appreciated by those of skill in the art that a new and useful backside light unit and an imaging system employing the same have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

I Claim:

1. An imaging system, comprising:
an illumination system that comprises: a light valve having an array of individually addressable pixels for providing light; and
a direct-view panel having an array of individually addressable pixels, wherein the direct-view panel is optically coupled to the pixels of the light valve such that light from the pixels of the light valve is capable of being directed to and modulated by the pixels of the direct-view panel.

2. The system of claim 1, further comprising:
an optical assembly disposed between the light valve and the direct-view panel such that light from different pixels of the light valve is delivered to substantially different pixels of the direct-view panel for illuminating said different pixels of the direct-view panel.

3. The system of claim 1, wherein the light valve comprises an array of reflective and deflectable micromirrors; and wherein the direct-view panel comprises an array of transmissive or semi-transmissive pixels.

4. The system of claim 1, wherein the optical assembly comprises:
an elongated light guide having an entrance coupled to the pixels of the light valve;
a wedge light guide having an exiting surface from which light exit from the wedge light guide; and
an optical element comprising a totally-internally-reflective surface coupled to an exit end of the elongated light guide and an entrance of the wedge light guide such that the light exiting from the exit end of the elongated light guide is capable of being delivered to the entrance of the wedge light guide.

5. The system of claim 4, wherein the exiting surface of the wedge light guide is substantially parallel to a plane of the pixels of the direct-view panel such that the light exiting from said exiting surface of the wedge light guide is capable of illuminating the pixels of the direct-view panel.

6. The system of 4, further comprising:
a condensing lens disposed such that a focal plane of the condensing lens is substantially at the plane of the light valve pixels; and another focal plane of the condensing lens is substantially at the entrance of the elongated light guide.

7. The system of claim 4, wherein the optical assembly is disposed a location such that a focal plane of the optical assembly is substantially at the pixels of the light valve; and another focal plane of the optical assembly is substantially at the pixels of the direct-view panel.

8. The system of claim 1, wherein the light valve and the direct-view panel have substantially the same native resolution or different native resolutions.

9. A system for use in a direct-view image system for delivering light onto a rear side of a direct view panel of the direct-view image system, the system comprising:
a light valve having an array of individually addressable pixels; and
a light-guide assembly comprising:
an elongated light-guide;
a tapered light-guide; and
an total-internally-reflective surface coupled to an exit end of the elongated light guide and to an entrance of the tapered light guide such that light exiting from the exit end of the elongated light guide is capable of being delivered to the entrance of the tapered light-guide.

10. The system of claim 9, wherein the light valve comprises an array of reflective and individually addressable pixels; and wherein the system further comprises: an illumination system for providing light.

11. The system of claim 10, wherein the light valve comprises an array of reflective and deflectable micromirrors.

12. The system of claim 9, wherein said elongated light-guide has an entrance that is optically coupled to the pixels of the light valve.

13. The system of claim 12, further comprising:
a condensing lens disposed between the light valve and the entrance of the elongated light-guide such that the pixels of the light valve are substantially imaged at a location that is substantially at the entrance of the elongated light-guide.

14. The system of claim 12, further comprising:
a condensing lens disposed between the light valve and the entrance of the elongated light-guide such that the pixels of the light valve are substantially imaged at a location that is within the elongated light-guide.

15. A method for producing an image, the method comprising:
generating an intermediate image based upon the image to be produced using an array of individually addressable pixels of a light valve;
projecting the intermediate image onto a rear side of a direct view panel comprising an array of individually addressable pixels; and
modulating the light of the intermediate image by the pixels of the direct-view panel so as to produce the image.

16. The method of claim 15, wherein the step of generating an intermediate image further comprises:
illuminating the pixels of the light valve with light from an illumination system.

17. The method of claim 15, wherein the step of projecting the intermediate image onto a rear side of a direct view panel further comprises:
projecting the intermediate image onto the rear side of the direct view panel using a light guide assembly that comprises an entrance couple to the light valve pixels and an exiting surface coupled to the pixels of the direct-view panel.

18. The method of claim 17, further comprising:
directing the light from the light valve pixels onto an entrance of an elongated light guide that comprises an exit end; and
directing the light exiting from the exit end of the elongated light-guide to an entrance of a tapered light guide that comprises an exit surface from which the light exits and propagates toward the rear side of the direct-view panel.

19. A method of displaying an image, comprising:
illuminating a first array of pixels with light;
modulating the light by a first array of pixels based upon one of a luminance component and a chromatic component of the image so as to generate an image component;
projecting said image component onto a second array of pixels; and
modulating the light of said image component by the second array of pixels based upon the other one of the luminance component and the chromatic component so as to produce the image.

20. The method of claim 19, wherein the first array of pixels modulates the light based upon the luminance component of the image so as to present the luminance of the image; and the second array of pixels modulate the light based upon the chromatic component of the image so as to present the chromaticity of the image.

21. The method of claim 20, wherein the first array of pixels modulates the light based upon the chromatic component of the image so as to present the chromaticity of the image; and the second array of pixels modulate the light based upon the luminance component of the image so as to present the luminance of the image.

22. The method of claim 19, wherein the pixels of the first pixel array are reflective and individually addressable pixels; and wherein the pixels of the second pixel array are transmissive or semi-transmissive pixels.

23. A method of displaying an image, comprising:
generating a luminance image component of the image by a first array of pixels;
generating a chromatic image component of the image by a second array of pixels; and
causing the generated luminance and chromatic image components to be displayed so as to produce the image.

24. The method of claim 23, wherein the step of generating the chromatic image component of the image by the second array of pixels further comprises:
projecting the luminance image component of the image to the second array of pixels; and
modulating the light of the luminance image component by the second array of pixels based upon the chromaticity of the image.

25. The method of claim 23, wherein the step of generating the luminance image component of the image by the first array of pixels further comprises:
projecting the chromatic image component of the image to the first array of pixels; and
modulating the light of the chromatic image component by the first array of pixels based upon the luminance of the image.
